(19) United States
(12) Patent Application Publication
(10) Pub. No.: US 2007/0200374 A1
(43) Pub. Date: Aug. 30, 2007

(54) Motor Vehicle Parts Including A Low Path Energy Absorber

(75) Inventors: Jean Troton, Munich (DE); Jean-Pierre Roux, Montee de Bellevue (FR)

Correspondence Address: OLIFF & BERRIDGE, PLC, P.O. BOX 19928, ALEXANDRIA, VA, 22320, US

(73) Assignee: Compagnie Plastic Omnium, Lyon (FR)

(21) Appl. No.: 11/630,340

(22) PCT Filed: Jun. 22, 2005
(86) PCT No.: PCT/FR05/01575

§ 371 Date: Feb. 13, 2007

(30) Foreign Application Priority Data
Jun. 23, 2004 (FR) 0406873

(51) Int. Cl. B60R 19/18

(52) U.S. Cl. 293/102

(57) ABSTRACT

A motor vehicle part including an energy absorber for positioning between a bumper skin and a rigid structure secured to the body of the vehicle, the part being characterized in that it comprises an air inlet grille secured to the energy absorber, said grille being provided with fastener means for fastening to the bumper skin.

The present invention relates to a motor vehicle part including a low path energy absorber.

In motor vehicles, there are low bearing members for protecting the legs of pedestrians in the event of an impact.

These low bearing members need to include a structure for decelerating the leg at the moment of impact without exceeding a certain threshold, above which the leg could suffer severe damage.

By way of example, there are European standards providing examples of such thresholds.

The low paths presently in use are often constituted of a combination of a rigid structure, e.g. a metal tube, situated inside the vehicle, and an energy absorber placed in front of the rigid structure which deforms in the event of an impact.

A difficulty associated with such a low path is that the absorber must be held behind the bumper skin. To make protection effective, it is desirable to leave minimum clearance between the energy absorber and the skin so that use is made of the entire penetration stroke of the leg in order to absorb the energy of the impact.

Nevertheless, it is known that fastening any part to a bodywork skin made of plastics material leads to problems of appearance since marks can then appear on the visible face of the skin as a result of welding or because of shrink marks that occur in register with ribs or fastening tabs.

The present invention seeks to provide a novel part that acts as an energy absorber between a bumper skin and a rigid structure providing a low force-transmission path, and that can be fastened to the bumper skin without any difficulty.

The present invention provides a motor vehicle part including an energy absorber for positioning between a bumper skin and a rigid structure secured to the body of the vehicle, the part being characterized in that it comprises an air inlet grille secured to the energy absorber, said grille being provided with fastener means for fastening to the bumper skin.

The part of the invention is thus the result of uniting in a single part both an air inlet grille and an energy absorber that is positioned between the low path rigid structure and the bumper skin.

In general, there is no difficulty involved with fastening the grille to the bumper skin, since the edges of the air inlet opening formed in the bumper skin can include means at the periphery of the air inlet opening for snap-fastening, adhesive bonding, or welding.

The part of the invention can thus be fastened to the bumper skin by the fastening means that are conventionally provided for an air inlet grille on its own.

The energy absorber which acts as a spacer between the rigid structure and the bumper skin makes it easy to adapt the shape of the bumper to the geometrical constraints imposed by the rigid structure, even when the bumper presents a rounded bulging shape that is very marked.

In a particular embodiment of the invention, the grille and the energy absorber are made as a single piece, e.g. being derived from the same molding operation.

Advantageously, the grille and the energy absorber are made of plastics material.

In order to make the invention better understood, there follows a description of an embodiment given by way of example that does not limit the scope of the invention, with reference to the accompanying drawings, in which:

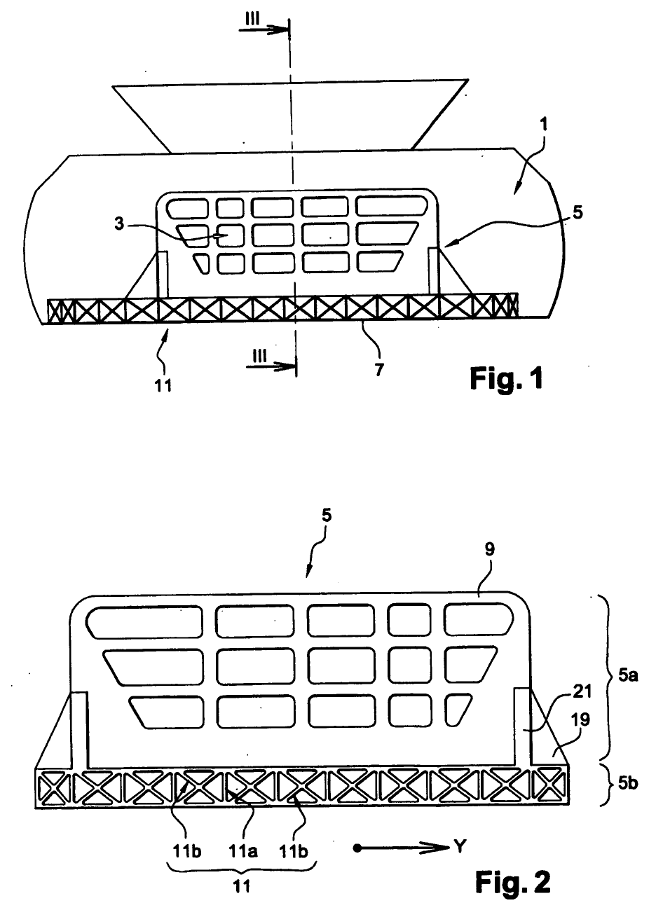

FIG. 1 is an inside view of a front bumper skin together with a part constituting an embodiment of the invention;

FIG. 2 is a view on a larger scale showing the part of FIG. 1 separate from the bumper; and

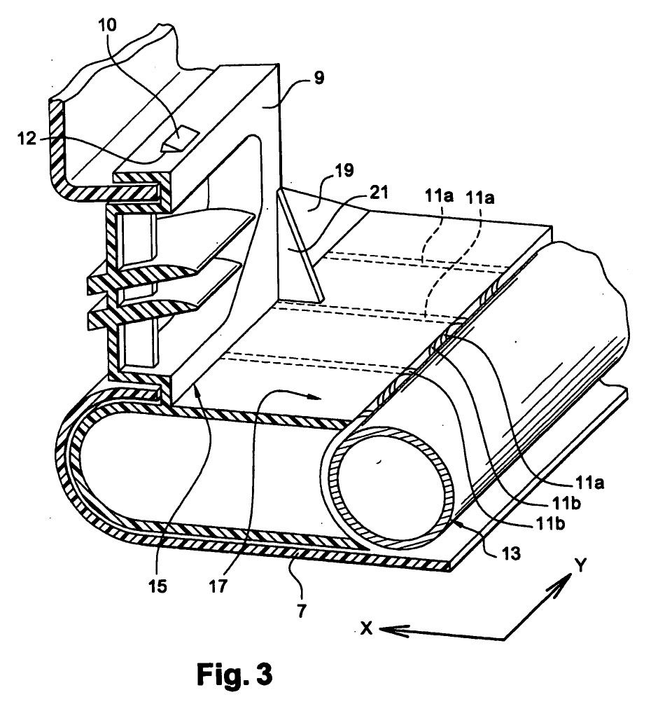

FIG. 3 is a view in perspective and in section on plane III-III of FIG. 1.

The bumper skin 1 shown in the drawings is made of polypropylene and includes, in a central portion and in its bottom zone, an air inlet opening 3 for feeding a cooling circuit (not shown).

A one-piece part 5 is placed against the inside face (shown in FIG. 1) of the bumper skin, in register with the air inlet opening 3 and along the bottom edge 7 of the skin.

This part, which can be seen more clearly in FIG. 2, comprises a top portion 5a constituting an air inlet grille of conventional configuration, and a bottom portion 5b constituting a pedestrian impact energy absorber.

FIG. 3 shows more clearly the shape of the air inlet grille and of the energy absorber.

The grille has a channel section surround 9 enabling it to be snap-fastened to the bumper skin 1 by means of conventional projecting shapes 10 provided on the skin around the surround of the air inlet opening 3, and by means of cutouts 12 formed in the channel section surround 9 of the grille.

The energy absorber is formed by an array of ribs 11 parallel to the longitudinal direction (X) of the vehicle.

In FIG. 2, it can be seen that vertical ribs 11a (vertical in the drawings) define cells of rectangular section having oblique ribs 11b formed therein in a cross configuration.

This distribution of ribs is known in itself and serves to absorb the energy of an impact directed along the longitudinal direction X of the vehicle.

During an impact, the ribs 11 buckle progressively as the leg penetrates into the bumper.

It can be seen that on its rear face, the energy absorber is shaped to fit against the structural part that is constituted by a metal tube 13 in the example shown.

Similarly, in front, the energy absorber substantially matches the shape of the inside face of the bumper skin 1 so as to match the style of the bumper to the shape of the metal tube.

Thus, if the bumper presents a very marked round bulging shape, there is no need for the metal tube to follow this bulging shape, given that the energy absorber may present length (in the longitudinal direction X) that varies at different points across the width of the vehicle.

Furthermore, the distribution of the ribs may vary as a function of position relative to the transverse direction (Y), as shown in FIG. 2, so as to optimize the resistance to deformation of the energy absorber at all points across the width of the vehicle.

The grille and the energy absorber are united by the bottom edge 15 of the grille, which is connected to the top plane 17 of the energy absorber, with these two parts being secured to each other as a result of both of them being obtained in a single molding operation.

On either side of the grille, vertical webs 19 (vertical in the position shown in the drawings) contribute to connecting the grille and the energy absorber for stiffening purposes.

Furthermore, a rib 21 that is orthogonal to the grille and vertical (in the position shown in the drawing) contributes to maintaining the right angle formed between the substantially vertical grille and the top plane 17 of the energy absorber.

Naturally, the embodiment described above does not have any limiting character and it may be modified in any desirable manner without thereby going beyond the ambit of the invention.

In particular, the grille and the absorber may comprise two separate parts that are united by fastener means that are strong enough to ensure that the energy absorber is firmly held behind the skin solely by the grille being fastened to the skin.

1. A motor vehicle part including an energy absorber for positioning between a bumper skin and a rigid structure secured to the body of the vehicle, wherein the part comprises an air inlet grille secured to the energy absorber, said grille being provided with fastener means for fastening to the bumper skin.

2. A motor vehicle part according to claim 1, in which the energy absorber is a low path energy absorber.

3. A motor vehicle part according to claim 1, in which the grille and the energy absorber are made as a single piece.

4. A motor vehicle part according to claim 3, in which the grille and the energy absorber are obtained by a single molding operation.

5. A motor vehicle part according to claim 1, in which the grille and the energy absorber are made of plastics material.
